(19) United States
(12) Patent Application Publication
(10) Pub. No.: US 2014/0334588 A1
(43) Pub. Date: Nov. 13, 2014

(54) SYSTEM FOR HANDLING FUEL ELEMENTS

(71) Applicants: Christian JURIANZ, Krefeld (DE); Stefan BAUER, Einhausen (DE); Stefan Oliver STECK, Ober-Ramstadt (DE)

(72) Inventors: Christian JURIANZ, Krefeld (DE); Stefan BAUER, Einhausen (DE); Stefan Oliver STECK, Ober-Ramstadt (DE)

(21) Appl. No.: 14/271,496

(22) Filed: May 7, 2014

(30) Foreign Application Priority Data
May 8, 2013 (DE) 102013104761.0

(51) Int. Cl. G21C 19/10

(52) U.S. Cl. CPC G21C 19/10
USPC 376/267

(57) ABSTRACT

A system for transferring fuel elements between an upper pool and a lower pool of a nuclear plant has a conveyor tube having an upper end at the upper pool and a lower end at the lower pool. A transport basket movable internally along the tube and into which at least one of the fuel elements can be placed can travel through the conveyor tube. A blocking element at one end of the tube that can fully close the conveyor tube at the respective end. A cable hoist has a traction cable guided through the conveyor tube for raising and lowering the transport basket through the conveyor tube. An intermediate partially closing blocking element offset from the fully closing blocking element in the tube is formed with a cable passage through which the traction cable can pass in the closed position.

### FIELD OF THE INVENTION

The invention relates to a system for transfer of fuel elements in a nuclear plant.

### BACKGROUND OF THE INVENTION

A typical nuclear plant has an upper pool and a lower pool of a nuclear plant, for example an upper pool in a reactor building and a lower pool of a fuel-element storage unit where the liquid level of the upper pool lies above the liquid level of the lower pool (during transport). The reactor can be a boiling-water reactor, for example, or also a pressurized-water reactor. Fuel rods are transferred between these pools by a system or apparatus comprising

a conveyor tube connecting the upper and the lower pool and extending at an acute angle to the vertical,

one or more transport baskets into each of which at least one of the fuel elements can be placed for transfer through the conveyor tube,

at least one blocking element that can block off the tube passage.

In such a nuclear plant, replacement and transfer of fuel elements has particular importance in practice. In this connection, fuel elements generally consist of a bundle of individual fuel rods, and the fuel element itself is equipped with a handle or the like so that it can be transported using suitable machines, for example in order to set it into the reactor vessel or remove it from the reactor vessel. Thus, spent fuel elements, in particular, must be removed from the reactor vessel and transported to a fuel-element storage unit, for example. Conversely, fresh fuel elements must be loaded into the reactor vessel. In practice, it is usual to fill the upper pool in the reactor building during the fuel element exchange, so that the fuel elements are transported in liquid (water). They are taken out of the open reactor vessel using a handler that can be moved above the reactor vessel, and moved into the upper pool and temporarily stored if necessary in a buffer pool/cooling pond. From the upper pool, the fuel elements must be transported to a fuel-element storage unit, for example, using a transfer system, the storage also being equipped with a (lower) pool, the upper pool (for example in the reactor building) and the lower pool (for example in the fuel-element storage unit) being filled to a different liquid level, independent of one another. Transport using the transfer system takes place between these two pools through a conveyor tube mounted at an angle to the vertical. Such transfer systems are basically known from practice. In this connection, an effort is made to keep the time expenditure for a fuel element exchange as short as possible, in order to reduce interruptions in the power operation of the reactor as much as possible. The reduction in the time required for the fuel element exchange has particular importance from an economic point of view.

A transfer system for fuel elements of a nuclear reactor facility is known from U.S. Pat. No. 3,952,885 in which the fuel elements are transported through a conveyor tube oriented at an angle to the vertical. The conveyor tube leads through the safety sheath that encloses the pressurized reactor vessel of a pressurized-water reactor in a gas-tight manner. The inner pool and the outer pool are filled to the same liquid level during the fuel element exchange, so that no blocking measures in the region of the conveyor tube are necessary during transfer of the fuel elements. Transport takes place using a cable hoist and using a carriage that has two chambers of which one accommodates a fresh fuel element for the trip there and the other a spent fuel element for the return trip. In this connection, the carriage can pivot from a vertical transfer position into a horizontal or angled transport position. The known transfer system exclusively serves for transfer of fuel elements between two pools that are filled to the same liquid is level.

The same holds true for the transfer system known from U.S. Pat. No. 4,096,031, with which fuel elements are transported directly between the reactor vessel and a storage container mounted directly next to it, where the reactor vessel and the storage container are connected with one another by a transport tube that extends at an acute angle to the vertical. Transfer devices are provided at the end of this conveyor tube that can pivot the fuel elements from an angled transport position into a vertical transfer position. Transfer through the conveyor tube takes place using a cable hoist that directly grips the fuel element with a grab.

U.S. Pat. No. 3,058,900 describes a charging apparatus for nuclear reactors in which fuel elements are transported directly between the reactor vessel and a channel that runs horizontally below the reactor vessel, the reactor vessel and the channel being connected with one another by a tube that is oriented at an angle to the vertical. For transport, a fuel element is inserted into a cartridge that can be transported through the tube, the cartridge being provided at the top with a handle or the like so that it can be gripped by a tool. The tube can be closed off completely using a blocking element. This blocking element is opened when a fuel element exchange takes place by means of the charging apparatus.

A loading and unloading apparatus for fuel elements is known from U.S. Pat. No. 4,202,729 in which the apparatus sits on the top of the reactor vessel and has two ramps extending at an angle to the vertical in opposite directions and between which the fuel elements can pivot using a pivoting apparatus. An apparatus having a similar construction is known from U.S. Pat. No. 4,440,718.

### OBJECTS OF THE INVENTION

It is therefore an object of the present invention to provide an improved apparatus for handling fuel elements.

Another object is the provision of such an improved apparatus for handling fuel elements that overcomes the above-given disadvantages, in particular that ensures fast and efficient transfer of fuel elements between an upper pool and a lower pool of a nuclear plant where the liquid level of the upper pool (even during transport) preferably lies above the liquid level of the lower pool.

### SUMMARY OF THE INVENTION

A system for transferring fuel elements between an upper pool and a lower pool of a nuclear plant where the liquid level of the upper pool lying above the liquid level of the lower pool has according to the invention a conveyor tube having an upper end at the upper pool and a lower end at the lower pool and extending between the upper and lower ends at an acute angle to the vertical. A transport basket movable internally along the tube and into which at least one of the fuel elements can be placed can travel through the conveyor tube. A blocking element at one end of the tube that can fully close the conveyor tube at the respective end. A cable hoist has a traction cable guided through the conveyor tube for raising and lowering the transport basket through the conveyor tube. An intermediate partially closing blocking element offset from the fully closing blocking element in the tube and movable between an open position allowing the basket to pass and a closed position blocking such passage is formed with a cable passage through which the traction cable can pass in the closed position.

In this connection, the invention first of all proceeds from the recognition that perfect transfer of the fuel elements through a conveyor tube is possible using a cable hoist. Such cable hoists are used in the transfer systems described above, in the state of the art, in which the two pools between which transport takes place are filled to the same liquid level, because in this case, blocking elements can easily be opened during transport. According to the invention, transport now takes place using a cable hoist between an upper pool and a lower pool filled to different liquid levels. In order to prevent the liquid from flowing out of the upper pool into the lower pool through the conveyor tube, at least one partially closing blocking element is integrated into the conveyor tube. A partially closing blocking element means in a blocking element that, while it can be brought into a completely open position on the one hand and into a closed position on the other hand, still has a cable passage in the closed position (closing position), and consequently a correspondingly dimensioned opening, so that the traction cable of the cable hoist can pass through the blocking element for perfect transfer. The slight leaks that might occur due to the cable passage, in this connection, can be accepted and compensated for again by appropriate pumping. The deciding factor is the fact that such leaks can be reduced to a minimum, using partially closing blocking elements according to the invention.

Preferably, the conveyor tube is equipped with a plurality of blocking elements, specifically on the one hand with one or more fully closing blocking elements without a cable passage, and on the other hand at least one partially closing blocking element with a cable passage. Thus, it is particularly preferably provided that the conveyor tube has at its upper end an upper fully closing blocking element without a cable passage and also has at its lower end a lower fully closing blocking element without a cable passage, and that furthermore at least one partially closing intermediate blocking element with a cable passage is provided between the upper and the lower blocking element. Such an embodiment, with fully closing blocking elements on the one hand and partially closing blocking elements on the other hand allows particularly efficient operation. This is because the fully closing blocking element(s) can ensure complete sealing of the conveyor tube, and can be closed, in particular when no transfer is taking place. But even during a transfer, the possibility exists of always closing the fully closing blocking element(s) since no traction cable is guided past these blocking elements.

Furthermore, it is particularly advantageous to integrate not just one partially closing intermediate blocking element into the conveyor tube, but rather a plurality of partially closing blocking elements, for example two partially closing blocking elements. In this manner, these blocking elements can be opened and closed one after the other, in terms of time, essentially like a lock system so that during lowering of the fuel elements through the conveyor tube, for example, the respective blocking elements only have to be completely opened for a short time as the fuel elements are passing through the blocking element.

The blocking elements can be configured in the most varied manner, in terms of design. Thus, it is practical to configure the upper and/or lower blocking elements, for example the fully closing blocking elements, as slides, for example as pneumatically, electrically or hydraulically driven slides. Alternatively, however, the upper/lower and/or fully closing blocking elements can also be configured as ball valves, for example pneumatically, electrically or hydraulically driven ball valves.

The partially closing blocking elements are preferably configured as ball valves whose balls are provided with cable passages. However, the possibility also exists, alternatively, of configuring the partially closing blocking elements as slides, and of providing their slide plates with cable passages. In the case of the partially closing blocking elements, too, a pneumatic actuator is preferably provided. Alternatively, electrical or hydraulic drives can also be used. The partially closing blocking elements each have at least one hole (for example in the valve ball or the slide plate) as a cable passage. This can be a groove, for example cut into the side of the valve ball (or slide plate) and running vertically, in the closed position, for example.

Because the upper and/or lower blocking element is/are generally provided in regions in which sufficient space is available, it is possible to advantageously work with slides there. However, the intermediate elements that are integrated into the conveyor tube are generally only accessible with difficulty and are provided in tight locations, because the conveyor tube in practice preferably runs through a concrete sleeve. At these locations in the concrete sleeve, ball valves are therefore preferably used; these take up little space and are also easier to replace in these tight locations than slides, for example.

Furthermore, it is optionally provided that the conveyor tube is provided with a cable port below the upper blocking element through which the traction cable passes from the tube interior to the cable winch. The cable of the cable hoist consequently does not enter the conveyor tube from the end, by the cable winch, but rather through the (upper) lateral cable port, so that the cable feed into the conveyor tube particularly takes place below the upper (fully closing) blocking element. This has the advantage that the upper blocking element can basically be closed again after introduction of the fuel elements into the conveyor tube, because transport is possible using the cable hoist even when the upper blocking element is closed. The upper blocking element consequently only has to be opened for a short period of time if the fuel elements must be lowered or raised through the region of the upper blocking element.

According to the invention, the fuel elements themselves are passed through the conveyor tube not directly, but rather in transport baskets. Preferably, each transport basket accommodates a plurality of fuel elements, for example four fuel elements, so that an accelerated fuel element exchange is possible.

In this connection, it is particularly practical if the cable hoist does not directly engage the transport baskets (at the top), but rather preferably, a lift carriage is guided through the conveyor tube on which the traction cable is carried, the transport baskets sitting on this lift carriage. The lift carriage is consequently provided underneath the transport basket during transport. Such an embodiment allows, among other things, a combination with the cable port below the upper blocking element, because the lift carriage does not have to travel completely out of the conveyor tube at the top, but rather merely as far as into the region of the upper end of the conveyor tube.

The transfer system according to the invention is preferably provided with an upper transfer device in the upper pool for loading fuel elements into and unloading them from the transport baskets and with a lower transfer device in the lower pool for loading fuel elements into and unloading them from the transport baskets. In this connection, two transport baskets can each be set into the upper transfer device and/or the lower transfer device, the baskets being horizontally displaceable for positioning above or below the conveyor tube and pivotable during displacement (preferably automatically) between a vertical transfer position and an angled transport position. The upper and/or lower transfer devices can each have two pivot frames into which a respective transport basket can be set and in which the transport baskets can pivot between a vertical transfer position and an angled transfer position. In this connection, it is practical if the two pivot frames, with the transport baskets provided in them, are mounted so as to pivot about a common horizontal axis in opposite directions, with the two pivot frames preferably being displaceable together horizontally and pivotable automatically during displacement (by the transport baskets set into them). In this preferred variant, pivoting of the transport baskets in the opposite direction consequently takes place simultaneously during positioning of the transfer device, so that trouble-free and fast transfer operation is possible. Particularly preferably, the transfer system has a total of three transport baskets, so that one transport basket is always in the upper transfer device and one transport basket in the lower transfer device, while the third transport basket can be passing through the conveyor tube. In this manner, transfer times can be significantly reduced. In detail, reference is made to the figure description in this regard.

Furthermore, it is practical that the transport baskets and/or the lift carriage is/are guided on guide rails by guide elements, for example guide rollers, the rails being mounted on the inside wall of the conveyor tube. If the transfer device with pivot frames as described is used, it is furthermore practical if the pivot frames are also equipped with guide rails for at least the transport baskets, and, if applicable, also for the lift carriage.

### BRIEF DESCRIPTION OF THE DRAWING

The above and other objects, features, and advantages will become more readily apparent from the following description, reference being made to the accompanying drawing in which:

FIG. 1 is a perspective vertical section through a nuclear plant with reactor building and fuel-element storage unit,

FIG. 2 is a large-scale detail view of the structure shown in FIG. 1 in the region of the upper transfer device,

FIG. 3 is a large-scale detail view of the structure shown in FIG. 1 in the region of the lower transfer device,

FIG. 4 is a different view of the upper transfer device,

FIG. 5 is a large-scale detail view of the structure shown in FIG. 4,

FIGS. 6a and 6b show the upper transfer device in two different functional positions,

FIGS. 7a and 7b are further large-scale detail views of the structure shown in FIG. 1 in a different view,

FIGS. 8a and 8b are large-scale detail views of the structure shown in FIG. 7a in different functional positions,

FIG. 9 is a different and partly cut-away view of the conveyor tube during transport, and

FIGS. 10a and 10b show the lower transfer device in different functional positions.

### SPECIFIC DESCRIPTION OF THE INVENTION

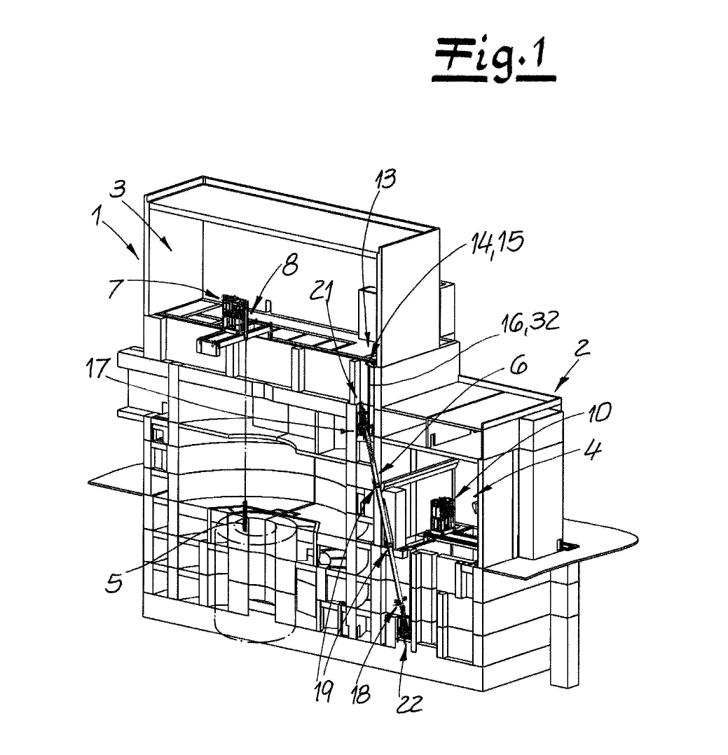

FIG. 1 shows in a simple view a nuclear reactor facility having a reactor building 1 in which an unillustrated nuclear reactor, for example a boiling-water reactor, is provided. A fuel-element storage unit 2 is provided next to the reactor building 1. An upper pool 3 filled to an upper level with liquid lies in the reactor building. A lower pool 4 filled to a lower liquid level is provided near the fuel-element storage unit 2. During a fuel element exchange, (spent) fuel elements 5, for example, are moved by a transfer system 6 out of the reactor, through the upper pool 3, and into the region of the lower pool 4 and/or conversely new fuel elements are transported upward. To remove the fuel elements 5 from the reactor vessel, a handler 7 is provided in the reactor building 1 that can remove a fuel element 5 from the reactor vessel, for example, and transport it to the transfer system 6 in the region of the upper pool 3. To this end, the handler 7 can be equipped with for example a telescoping grab 8 that can grip a handle 9 of the fuel element 5. Similarly, a handler 10 provided in the fuel-element storage unit 2 can move the fuel elements 5 away from or to the transfer system 6. The present invention concerns itself with the transfer system 6 that can transport the fuel elements 5 between the upper pool 3 of the reactor building 1 and the lower pool 4 of the fuel-element storage unit 2, the liquid level of the upper pool lying above the liquid level of the lower pool. The transfer system 6 has a conveyor tube 11 extending at an acute angle to the vertical between the upper and lower pools. Furthermore, the transfer system has a plurality of transport baskets 12, i.e. the fuel elements themselves are transported through the conveyor tube 11 not directly, but rather in the transport baskets 12, and in this embodiment four fuel elements can be set into a transport basket. Furthermore, the transfer system 6 has a cable hoist 13 in turn that has a cable winch 14, a drive 15, and a traction cable 16 and that works in the conveyor tube 11 for raising and lowering the transport baskets 12. The conveyor tube 11 is equipped with a plurality of blocking elements 17, 18, and 19 that can close off the tube passage to prevent or minimize flow of liquid from the upper pool 3 into the lower pool 4. The conveyor tube 11 is provided at its upper end with an upper fully closing blocking element 17, and, at its lower end, with a lower fully closing blocking element 18, these blocking elements 17, 18 being configured as slides. Sufficient space is available at these locations for use of slides. A plurality of further blocking elements, namely a plurality of partially closing intermediate elements 19, are provided between the upper blocking element 17 and the lower blocking element 18; in this embodiment, these are configured as ball valves. Ball valves are used at these locations because the conveyor tube 12 runs inside a concrete sleeve and relatively little space is available.

The difference between the fully closing blocking elements 17 and 18 and the partially closing blocking elements 19 is that the partially closing blocking elements are provided with a cable passage 30 through which the traction cable 16 can pass in the closed position of the blocking element 19. In contrast, the fully closing blocking elements 17 and 18 are configured without such cable passages. The blocking elements 17, 18, and 19 must be opened completely to be able to move a transport basket 12 through the respective locations. The partially closing blocking elements 19 can, however, be closed after the transport basket 12 has passed because the traction cable 16 of the cable hoist passes through the cable passage 30 even in the closed valve position. The transfer system 6 furthermore has a lift carriage 20, i.e. the traction cable 16 of the cable hoist 13 does not engage the transport baskets 12, but rather is connected with the separate lift carriage 20 that engages underneath the transport basket 12, i.e. the transport basket 12 is set onto the lift carriage 20 during transfer. The advantages of this configuration will be discussed below.

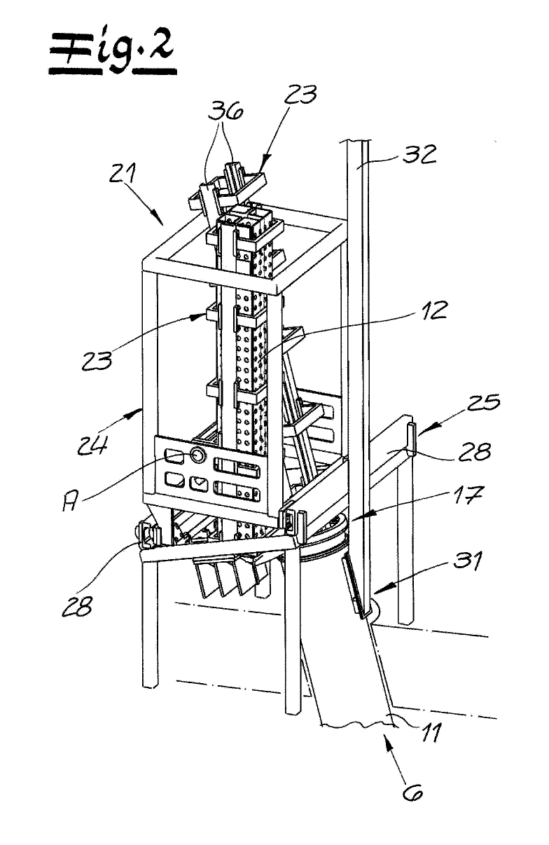

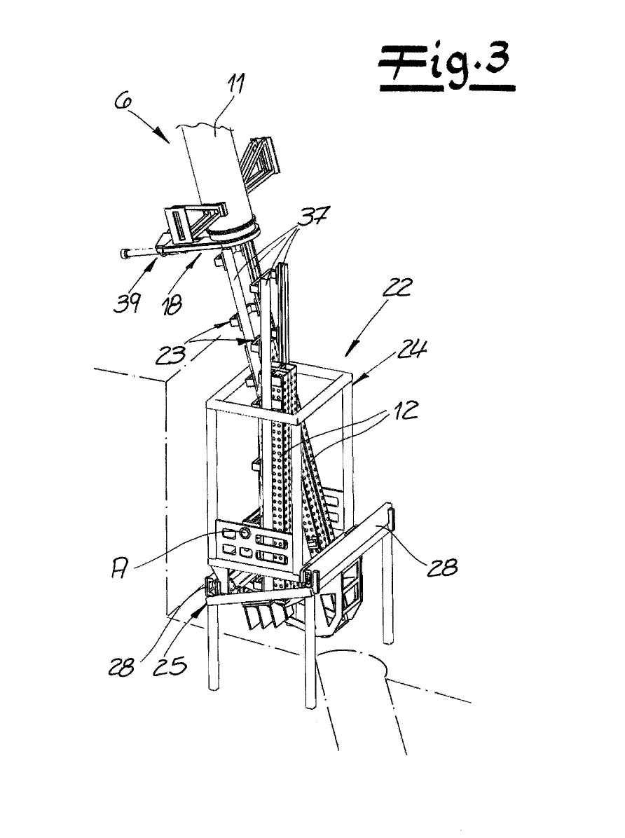

Furthermore, the transfer system 6 according to FIG. 2 has an upper transfer device 21 in the upper pool 3 for loading the fuel elements 5 into and/or unloading them from the baskets 12. In the lower pool 4, the transfer system 6 has a lower transfer device 22 (FIG. 3) for loading the fuel element 5 into and/or unloading them from the baskets 12.

For the transfer of the fuel elements 5 from the upper pool 3 into the lower pool 4, first a transport basket 12 is loaded with fuel elements 5 by the upper transfer device 21. Then, the transport basket 12 is transported by the upper transfer device 21 through the conveyor tube 11 into the region of the lower transfer device 22, specifically using the cable hoist 13. In the lower transfer device 22, the fuel elements 5 can then (for example using the handler 10) be removed from the transport basket 12. Subsequently, the transport basket 12 (for example empty without fuel elements) can be transported back up through the conveyor tube 11, again using the cable hoist 13.

In order to guarantee a rapid and thereby efficient transfer, the upper transfer device 21 and the lower transfer device 22 can each be loaded with two of the baskets 12 that can be displaced horizontally for positioning above or below the conveyor tube 11, and, during displacement can pivot, preferably automatically, between a vertical transfer position and an angled transport position. The transport baskets 12 are consequently loaded with the fuel elements 5 in the vertical transfer position and accordingly the fuel elements 5 are also removed from the transport baskets 12 in this vertical transfer position. For transport through the conveyor tube 11, the transport baskets 12 are then pivoted into the angled transport position. In this embodiment, this pivoting of the transport baskets 12 takes place automatically during displacement of the transport baskets 12. This will be explained first using the upper transfer device 21 as an example. The upper transfer device 21 is equipped with two pivot frames 23 into each of which a transport basket can be set and in which the transport baskets 12 can pivot between a vertical transfer position and an angled transport position. In this connection, the two pivot frames 23, with the transport baskets 12 provided in them, are mounted so as to pivot about a common (horizontal) axis A in opposite directions. The two pivot frames 23 can be jointly displaced horizontally, and can be automatically pivoted by the transport baskets 12 set into them, during displacement, specifically in opposite directions. To this end, the two pivot frames 23 are mounted so as to pivot in a common displacement frame 24 and can be displaced with it, the pivot frames with the transport baskets 12 set into them being positionable relative to the conveyor tube by displacement of the displacement frame 24 in the support frame 25, and, in this connection, being automatically pivotable. This is possible by means of control rails 26 that are curved in this embodiment, the pivot frames 23 or the transport baskets 12 set into them being guided in the control rails 26 during displacement such that the transport baskets 12 pivot automatically because the transport baskets 12 in this embodiment have control pins 27 on the lower side that engage into the control rails 26. In this connection, the support frame 25 has two guide rails 28 in which the displacement frame 24 is guided horizontally and linearly, specifically by a drive 29.

The lower transfer device 22 is configured similarly, and also has a support frame 25, a displacement frame 24, and two pivot frames 23. Preferably, three transport baskets are provided.

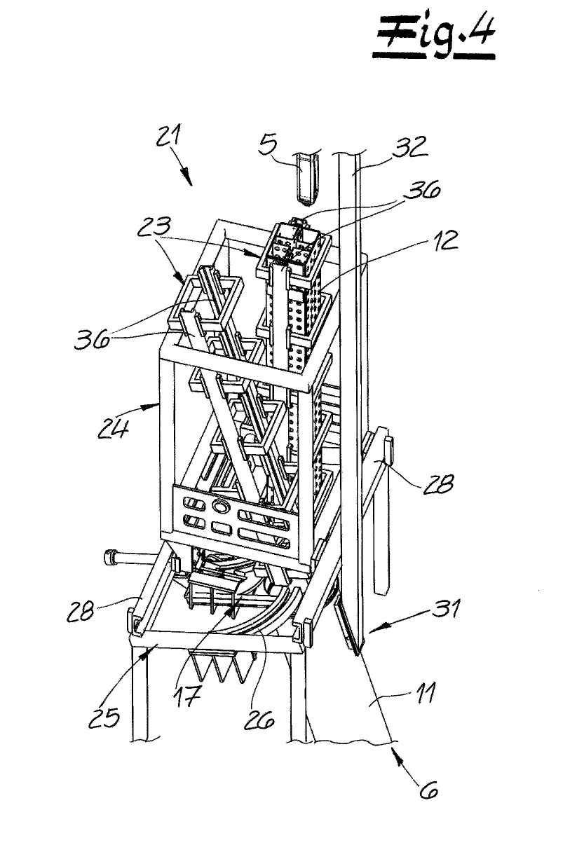

The method of functioning of the transfer system 6 according to the invention will now be explained using FIGS. 4 to 10a and 10b. First, the fuel elements 5 are removed from the reactor vessel using the handler 7 and transported into the region of the upper transfer device 21. There, a transport basket 12 is in a pivot frame 23, in the vertical transfer position, so that four fuel elements can be set into the transport basket 12 (see FIG. 4). This transport basket 12 is situated, in the vertical transfer position laterally offset next to the conveyor tube 11. An empty transport basket 12 is above the conveyor tube 11, for example, in the angled transport position where this empty transport basket 12 was transported upward during loading of the other transport basket from the region of the lower transfer device 22, for example.

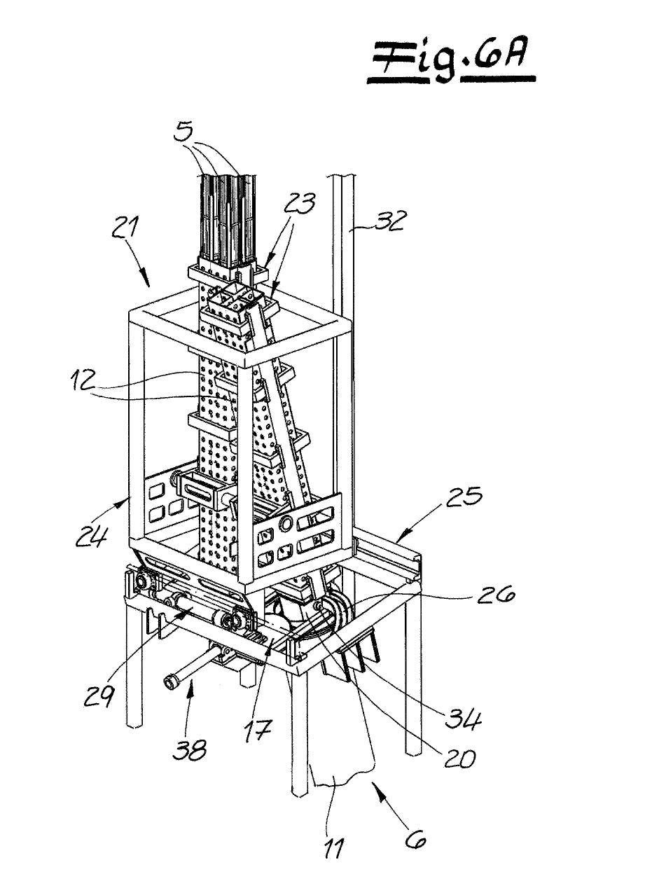

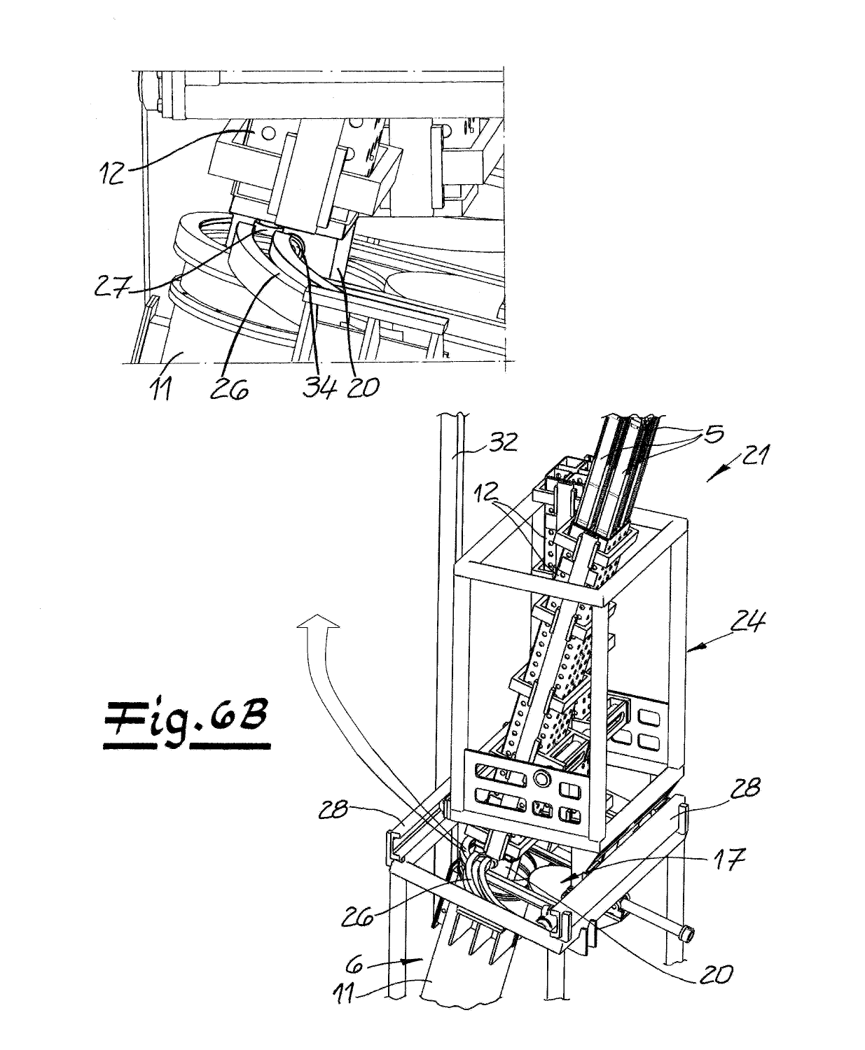

In order to now position the filled transport basket 12 above the conveyor tube 11, the displacement frame 24 with the pivot frames 23 provided in it is displaced. This is evident from a comparison of FIGS. 6a and 6b that show the upper transfer device 21 in different functional positions and in different views. The transport baskets 12 engage into the control rails 26 with their lower control pins 27, so that during displacement of the displacement frame 24, and thereby also of the pivot frames 23, these pivot frames 23 with the transport baskets 12 set into them pivot in opposite directions, so that the filled transport basket 12 is not only positioned above the conveyor tube 11, but also, at the same time, pivoted from the vertical transfer position into the angled transport position.

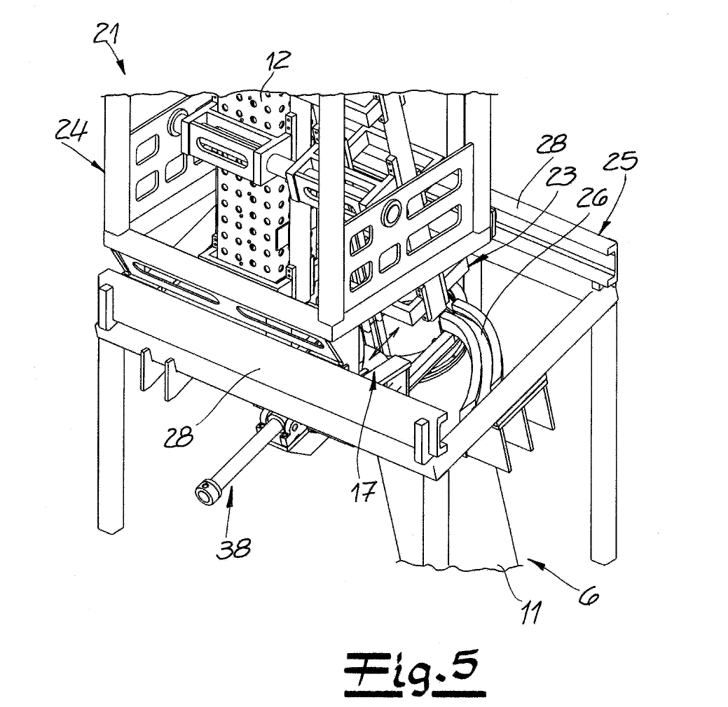

The lift carriage 20, with which an empty transport basket 12 was previously transported from below to above, is consequently still in the region of the upper end of the conveyor tube 11, so that the filled transport basket 12 is set onto the lift carriage 20 during displacement of the displacement frame 24. The upper blocking element 17 is open, in this connection (see FIG. 5).

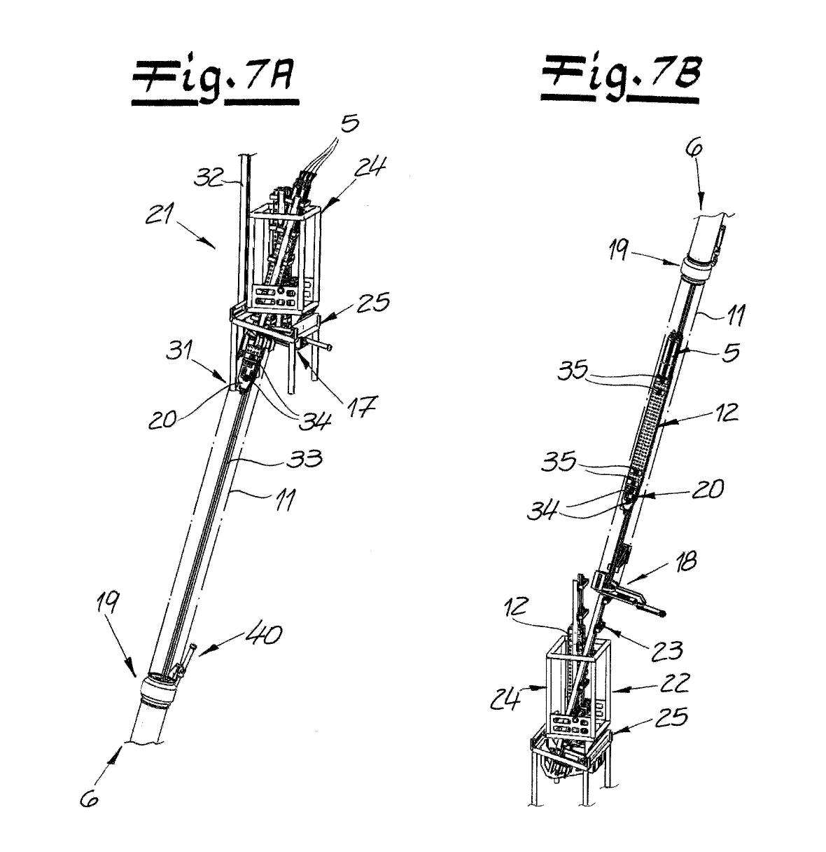

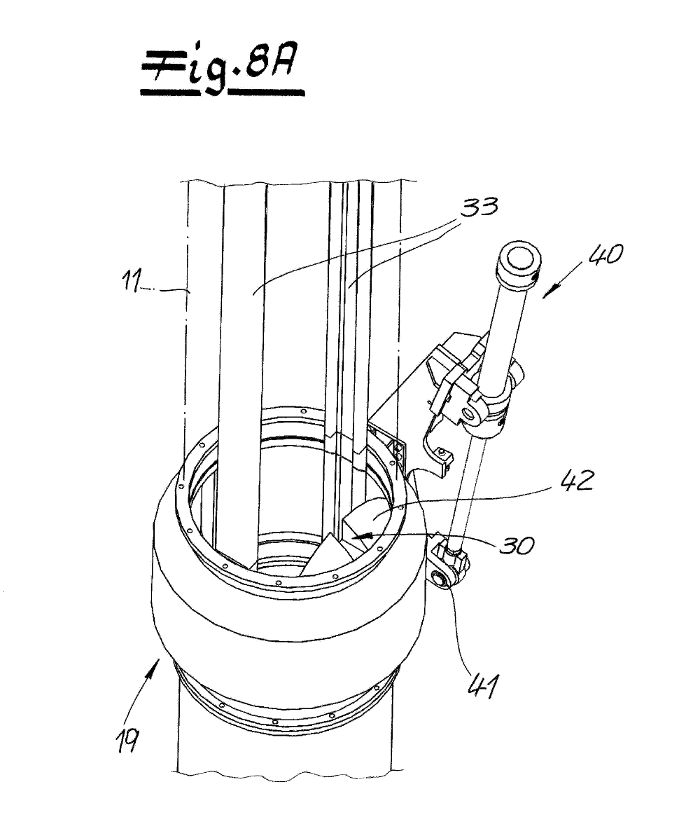

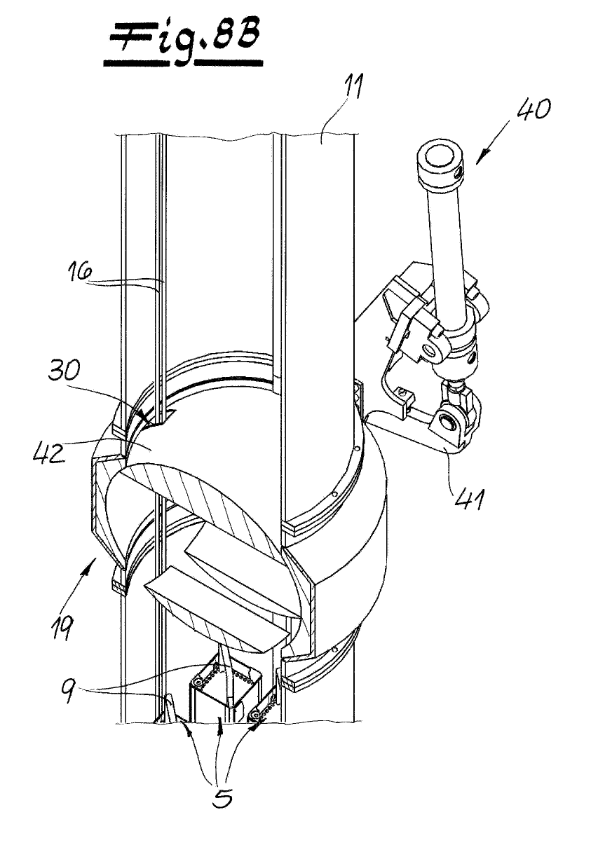

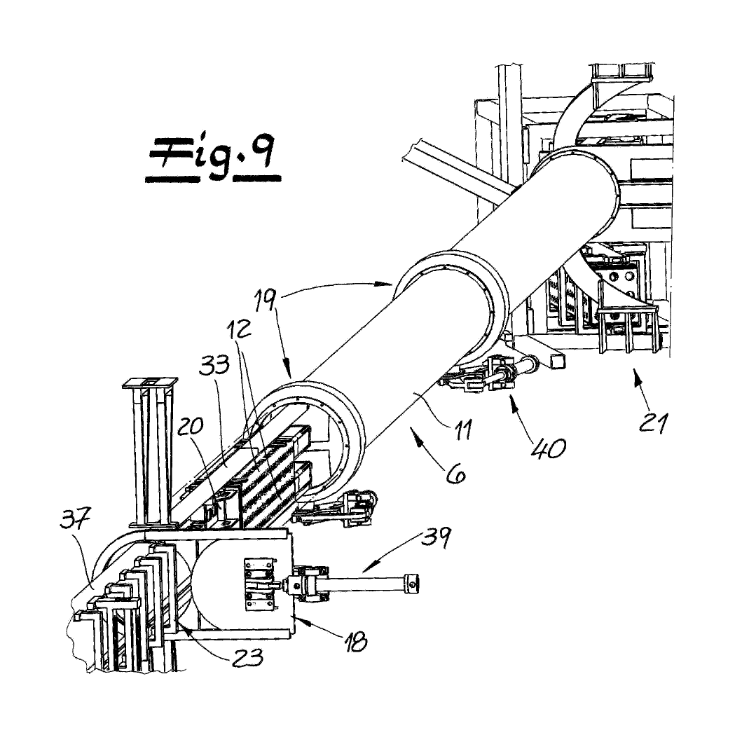

Now the lift carriage 20, with the filled transport basket 12 set onto it, can be lowered using the cable hoist 13 (see FIGS. 7a and 7b). The lower blocking element 18 is closed, at first. The same holds true for the intermediate valves (ball valves 19) inside the conveyor tube 11. During lowering of the lift carriage 20 with the transport basket 12, the intermediate valves 19 are then individually opened step by step, in the manner of a lock system, and, after the lift carriage with transport basket 12 has moved through, are immediately closed again. This is possible because the intermediate valves 19 each have a cable passage 30 through which the traction cable 16 can pass in the closed position of this valve. In this manner, flow of liquid out of the upper pool 3 into the lower pool 4 during transport is prevented (see FIGS. 8a and 8b).

Before the transport basket 12 can exit the conveyor tube 11 at the lower end, the lower slide 18 is opened. In this regard, reference is made to FIG. 9 that shows the conveyor tube 11 in a view at an angle from below. It can be seen that the transport basket 12 is lowered below the lower intermediate valve 19, where this intermediate valve 19 is closed. The lower slide 18 is opened.

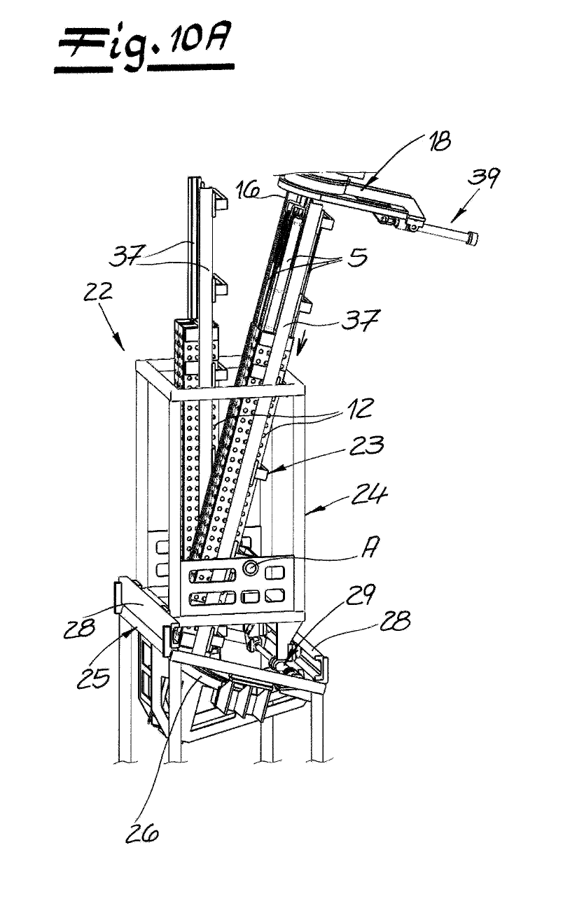

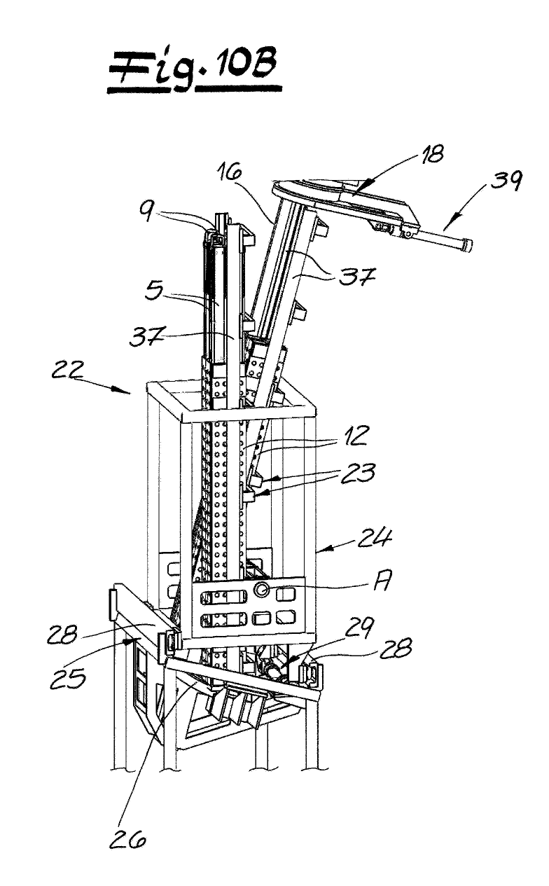

The lift carriage 20 with the transport basket 12 set onto it then exits from the conveyor tube 11 on the lower side, and consequently enters into the lower transfer device 22. In this regard, reference is made to FIGS. 10a and 10b.

Consequently, the filled transport basket 12 is in the angled transport position in the lower transfer device 22, and furthermore, once again an empty transport basket 12 is provided in the vertical transfer position. The displacement frame 24 can be displaced again, so that the transport baskets are positioned and pivoted accordingly. The filled transport basket 12 consequently assumes the vertical transfer position, while the empty transport basket 12 assumes the angled transport position below the conveyor tube 11. Now the empty transport basket 12 can once again be transported upward with the lift carriage 20. During the same time, the filled transport basket 12 can be unloaded by the lower handler 10.

This makes it clear that the fuel elements can be transferred rapidly. In particular, loading can take place in the upper transfer device, and unloading can take place in the lower transfer device, at the same time. In particular, transport of a further transport basket 12 can be done by the transfer system during loading and unloading. Consequently, at least two transport baskets are preferably provided. In this embodiment, however, three transport baskets are provided, one transport basket always being in the upper transfer device and one transport basket in the lower transfer device, while a third transport basket can be transported between the upper transfer device and the lower transfer device.

FIG. 2, further shows that the traction cable 16 of the cable hoist 13 does not enter into the conveyor tube through the upper end of the conveyor tube 11, but rather that the conveyor tube 11 has below the upper slide 17 a lateral cable port 31 through which the traction cable 16 passes out of the tube interior to the cable winch 14, specifically through a cable guide tube 32. This cable port 31 is consequently provided below the slide 17 and, in particular, below the upper transfer device 21. Such a cable port is particularly practical in connection with the lift carriage 20 that, as described, is underneath the transport baskets 12.

The figures furthermore show guide rails 33 inside the conveyor tube 11. The lift carriage 20 is equipped with guide elements, namely rollers 34 that are guided in these rails 33. The transport baskets are also equipped with guide elements 35 in the form of rollers also guided in the guide rails 33. Furthermore, guide rails 36 are also provided in the region of the upper transfer device 21, as are guide rails 37 in the region of the lower transfer device.

The upper transfer device 21 and the lower transfer device 22 are configured to be functionally equivalent in this embodiment. They differ, in terms of design, in specific details. This relates, for example, to the pivot frames 23. The pivot frames 23 of the upper transfer device are laterally closed on all sides, while the pivot frames 23 of the lower transfer device are open on one side. This is connected with the fact that the traction cable 16 in the lower transfer device 22 must be guided past the pivot frames 23, so pivoting of the pivot frames 23 must not be hindered by the traction cable.

Finally, the figures also show that the blocking elements 17, 18, and 19 are operated pneumatically. To this end, the upper slide 17 is provided with a pneumatic actuator 38. The lower slide 18 is also provided with a pneumatic actuator 39. The ball valves 19 are also provided with linearly acting pneumatic actuators 40 that engage the valve ball 42 of the valve 19 via a crank arm 41, this valve ball 42 having the cable passage 30 as described, configured as a hole of the valve ball 42.

In this embodiment, pneumatic actuators are indicated. Alternatively, however, electrical or hydraulic drives can also be used.

We claim:

1. A transfer system for transfer of fuel elements between an upper pool and a lower pool of a nuclear plant, the liquid level of the upper pool lying above the liquid level of the lower pool, the system comprising:
a conveyor tube having an upper end at the upper pool and a lower end at the lower pool and extending between the upper and lower ends at an acute angle to the vertical;
a transport basket movable internally along the tube and into which at least one of the fuel elements can be placed for transfer through the conveyor tube;
a fully closing blocking element at one end of the tube that can fully close the conveyor tube at the respective end;
a cable hoist having a traction cable guided through the conveyor tube for raising and lowering the transport basket through the conveyor tube; and
an intermediate partially closing blocking element offset from the fully closing blocking element in the tube, movable between an open position allowing the basket to pass and a closed position blocking such passage, and formed with a cable passage through which the traction cable can pass in the closed position.

2. The system according to claim 1, wherein the fully closing blocking element is at the upper end and does not have a cable passage, the system comprising:
a lower fully closing lower blocking element without a cable passage at the lower end, the partially closing intermediate blocking element being between the fully closing upper and lower blocking elements.

3. The system defined in claim 1, wherein the fully closing blocking elements are slides or ball valves.

4. The system defined in claim 1, wherein the partially closing blocking element is as a ball valves or slide whose valve ball or slide plate is provided with the cable passage.

5. The system defined in claim 1, further comprising:
a lift carriage movable through the conveyor tube, connected to the traction cable, and adapted to carry the basket.

6. The system defined in claim 1, further comprising:
respective upper and transfer device at the upper and lower ends in the upper and lower pools for loading the fuel elements into and unloading them from the transport baskets, each transfer device being adapted to hold two of the transport baskets, the baskets being displaceable for positioning above or below the conveyor tube by pivoting between a vertical transfer position and an angled transport position.

7. The system defined in claim 6, wherein the upper and lower transfer devices each have two pivot frames, into each of which a respective transport basket can be set and in which the transport baskets can pivot between the vertical transfer position and the angled transport position, the pivot frames with the transport basket in them being mounted so as to pivot about a common axis in opposite directions.

8. The system defined in claim 7, further comprising:
guide rails at the tube ends on which the pivot frames or the transport baskets set into them are guided during displacement in such a manner that the transport baskets automatically pivot; and
lower-side control pins on the transport baskets guided in the control rails.

9. The system defined in claim 8, further comprising:
elements guiding the transport baskets and/or the lift carriage on the guide rails inside the conveyor tube/

10. The system defined in claim 9, wherein the upper and the lower pivot frame are provided with guide rails for the transport baskets or the lift carriage.

11. The system defined in claim 1, wherein the conveyor tube is provided with a cable port below the upper end and through which inlet the traction cable passes from inside the tube to the cable winch.
